(19) United States
(12) Patent Application Publication
(10) Pub. No.: US 2026/0264945 A1
(43) Pub. Date: Sep. 10, 2026

(54) Dispensing container

(71) Applicant: NV International (Asia) Limited, Kowloon Bay (HK)

(72) Inventor: Pik Yung Teresa WU, Kowloon Bay (HK)

(21) Appl. No.: 19/070,590

(22) Filed: Mar. 5, 2025

(51) Int. Cl. B65D 47/18; B65D 51/18

(52) U.S. Cl. CPC B65D 47/18; B65D 51/18; B65D 2251/0015; B65D 2251/0087

(57) ABSTRACT

A dispensing container including a container, a cap assembly, a tube assembly, an actuator assembly, and a suction space. The tube assembly is axially movable in relation to the cap assembly between a default position where the tube seat is distal from a bottom end of the cap assembly and a ready-to-dispense position where the tube seat is proximal to the bottom end of the cap assembly. The actuator assembly is axially movable in relation to the cap assembly between a biased resting position and a pressed positon which is more proximal to the container than the biased resting position, and the suction space has a smaller volume in the pressed position than in the biased resting position.

### BACKGROUND OF THE INVENTION

The present invention relates to a dispensing container for dispensing liquid content stored therein.

Dispensing containers which make use of dropper mechanism to dispense liquid content are commonly available in the marketplace. However, operation of the dropper mechanism involves a number of steps, which include first removing the cap from the container, dipping the dropper tube inside the container till the bottom end of the dropper tube reaches the liquid content in the container; squeezing the bulb of the dropper to suck in the liquid content to the bulb; releasing the bulb of the dropper to discharge the liquid content in the bulb to the user’s skin, and finally re-engaging the cap with the container. Such operation is inconvenient and time consuming.

### BRIEF SUMMARY OF THE INVENTION

In view of the aforesaid disadvantages now present in the prior art, it is an object of the present invention to provide a dispensing container which is convenient to operate.

To attain this, the present invention provides a dispensing container comprising a container for receiving liquid content therein, a cap assembly removably engaged with an opening portion of the container, a tube assembly comprising a tube seat movably received within the cap assembly and a tube extended from a bottom end of the tube seat into the container, an actuator assembly having an actuator and a piston fixedly coupled to the actuator and movably received within the tube seat, a suction space formed within the tube assembly between the piston and the bottom end of the tube seat; the tube assembly being axially movable in relation to the cap assembly between a default position where the tube seat is distal from a bottom end of the cap assembly and a ready-to-dispense position where the tube seat is proximal to the bottom end of the cap assembly; at the default position, the bottom end of the tube seat is limited from moving further towards the bottom end of the cap assembly by a first limiting means, the piston is positioned at a non-suction position in relation to the tube seat and the suction space has a first volume; at the ready-to-dispense position, the bottom end of the tube seat is limited from moving further towards the bottom end of the cap assembly by a second limiting means, the piston is positioned at a suction position in relation to the tube seat and the suction space has a second volume; the suction position is more distal from the bottom end of the tube seat than the non-suction position, and the second volume is larger than the first volume; the actuator assembly being axially movable in relation to the cap assembly between a biased resting position and a pressed position which is more proximal to the container than the biased resting position, and the suction space has a smaller volume in the pressed position than in the biased resting position.

Preferably, a compression spring having a first end and a second end is disposed in the cap assembly; the first end of the compression spring is configured to abut against the actuator assembly to bias the actuator assembly towards the biased resting position; the second end of the compression spring is configured to abut against the tube assembly to bias the tube assembly towards the ready-to-dispense position.

Preferably, the second limiting means comprises a third limiting member radially protruding from an outer circumferential surface of the tube seat and a fourth limiting member disposed in the cap assembly; the third limiting member is abutted against the fourth limiting member to prevent the tube seat from moving further towards the bottom end of the cap assembly. The third limiting member is in form of a flange radially protruding from the outer circumferential surface of the tube seat. The second end of the compression spring is abutted against the third limiting member radially protruding from an outer circumferential surface of the tube seat. The first limiting means comprises a first limiting member formed by the bottom end of the tube seat and a second limiting member formed by a top end of the opening portion; the bottom end of the tube seat is abutted against the top end of the opening portion to prevent the tube seat from moving further towards the bottom end of the cap assembly.

Preferably, the tube is configured to have a length such that when the tube assembly is at the default position, a bottom end of the tube is positioned adjacent to a bottom end of the container.

Preferably, the cap assembly comprises an outer cap having a hollow interior; and an inner cap fixedly coupled to a bottom end of the hollow interior of the outer cap and provided with a threaded inner surface to threadedly engage with the opening portion of the container. The fourth limiting member is form of an upper rim of the inner cap.

Preferably, the actuator is in form of a tubular button having a hollow interior; the first end of the compression spring is abutted against a top end of the hollow interior.

Preferably, the opening portion is in form of a threaded neck opening at a top end of the container.

Preferably, a wiper is provided in the opening portion of the container; the wiper has an inner wall which is tightly sleeved on an outer surface of the tube.

### BRIEF DESCRIPTION OF THE DRAWINGS

FIG. 1 is an exploded view of an embodiment of the present invention.

FIG. 2 is another exploded view of the embodiment as shown in FIG. 1.

FIG. 3 is a sectional view of the embodiment as shown in FIG. 1 when the tube assembly is at the default position.

FIG. 4 is a sectional view of the embodiment as shown in FIG. 1 when the tube assembly is at the ready-to-dispense position and the cap assembly is partially engaged with the container.

FIG. 5 is a sectional view of the embodiment as shown in FIG. 1 when the tube assembly is at the ready-to-dispense position and the cap assembly is completely disengaged from the container.

### DETAILED DESCRIPTION OF THE INVENTION

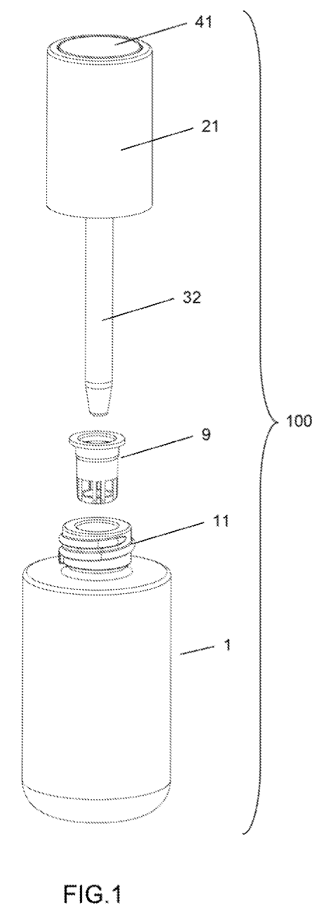

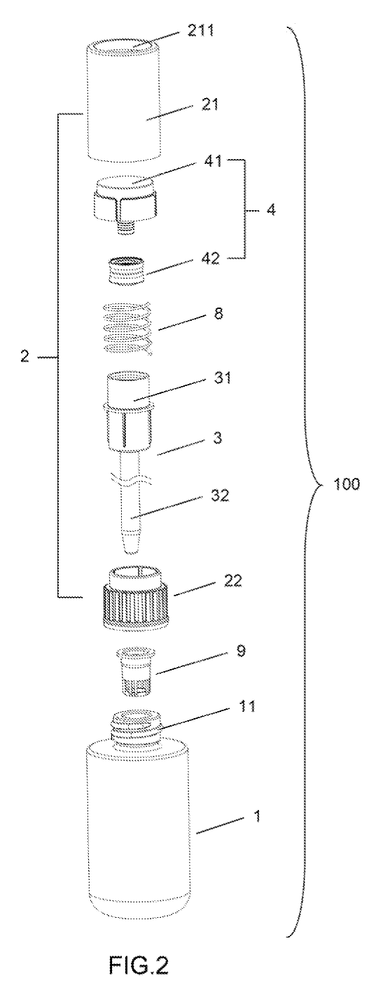

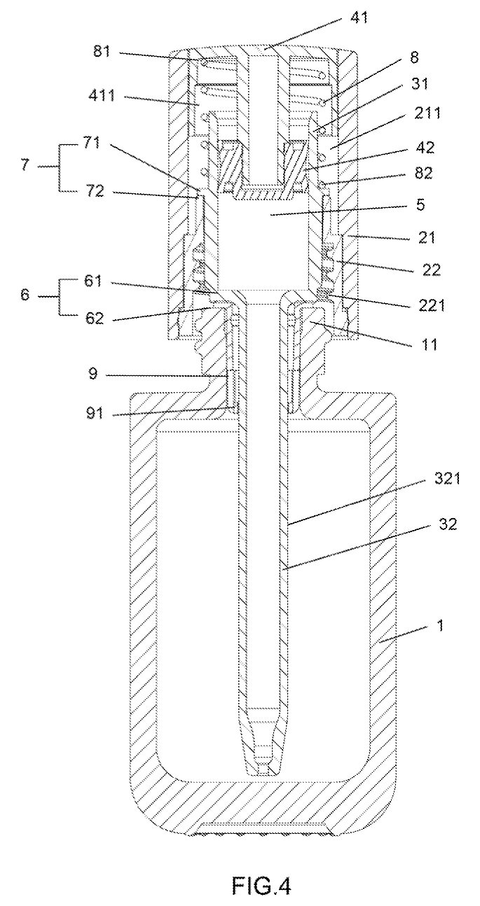

As illustrated in FIGS. 1 to 5, the dispensing container 100 of the present embodiment comprises a container 1, a cap assembly 2, a tube assembly 3 and an actuator assembly 4.

The container 1 is configured for receiving liquid content such as cosmetics therein. The container 1 has an opening portion 11. In this embodiment, the opening portion 11 is in form of a threaded neck opening at a top end of the container 1.

The cap assembly 2 is removably engaged with the opening portion 11 of the container 1. In this embodiment, the cap assembly 2 is engaged with the opening portion 11 of the container 1 by a screw-on mechanism. In other embodiments not shown in the figures, the cap assembly 2 may also be engaged with the opening 11 of the container 1 by other mechanisms such as a snap-on mechanism. The cap assembly 2 comprises an outer cap 21 and inner cap 22. The outer cap 21 has a hollow interior 211. The inner cap 22 is fixedly coupled to a bottom end of the hollow interior 211 of the outer cap 21 and is provided with a threaded inner surface 221 to threadedly engage with the opening portion 11 in form of a threaded neck opening of the container 1.

The tube assembly 3 comprises a tube seat 31 and a tube 32. The tube seat 31 is movably received within the cap assembly 2. The tube 32 is extended from a bottom end of the tube seat 31 into the container 1.

The actuator assembly 4 comprises an actuator 41 and a piston 42. The piston 42 is fixedly coupled to the actuator 4 and movably received within the tube seat 31. A suction space 5 is formed within the tube assembly 3 between the piston 42 and the bottom end of the tube seat 31.

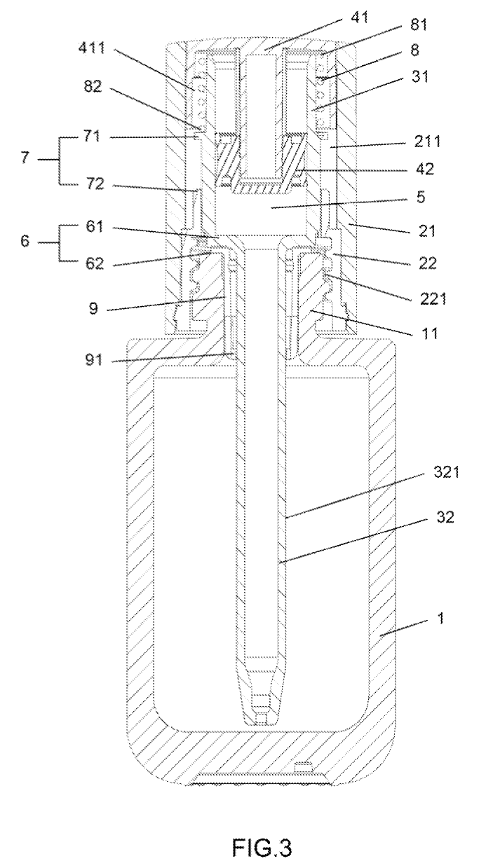

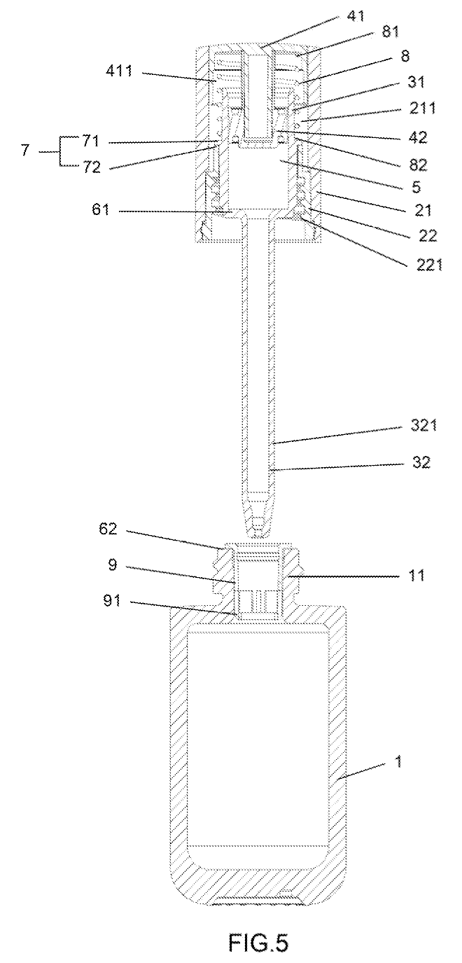

The tube assembly 3 is axially movable in relation to the cap assembly 2 between a default position and a ready-to-dispense position. As shown in FIG. 3, when the tube assembly 3 is at the default position, the tube seat 31 is located distal from a bottom end of the cap assembly 2. As shown in FIG. 5, when the tube assembly 3 is at the ready-to-dispense position, the tube seat 31 is located proximal to the bottom end of the cap assembly 2. As shown in FIG. 3, when the tube assembly 3 is at the default position, the bottom end of the tube seat 31 is limited from moving further towards the bottom end of the cap assembly 2 by a first limiting means 6, the piston 42 is positioned at a non-suction position in relation to the tube seat 31 and the suction space 5 has a first volume. As shown in FIG. 5, when the tube assembly 3 is at the ready-to-dispense position, the bottom end of the tube seat 31 is limited from moving further towards the bottom end of the cap assembly 2 by a second limiting means 7, the piston 42 is positioned at a suction position in relation to the tube seat 31 and the suction space 5 has a second volume. The suction position is more distal from the bottom end of the tube seat 31 than the non-suction position. The second volume is larger than the first volume. In this embodiment, the first limiting means 6 comprises a first limiting member 61 formed by the bottom end of the tube seat 31 and a second limiting member 62 formed by a top end of the opening portion 11, i.e. the upper rim of the opening portion 11. The second limiting means 7 comprises a third limiting member 71 in form of a flange radially protruding from an outer circumferential surface of the tube seat 31, and a fourth limiting member 72 in form of an upper rim of the inner cap 22 disposed in the cap assembly 2. Furthermore, the tube 32 is configured to have a length such that when the tube assembly 3 is at the default position, a bottom end of the tube 32 is positioned adjacent to a bottom end of the container 1.

The actuator assembly 4 is axially movable in relation to the cap assembly 2 between a biased resting position and a pressed position. The pressed position is more proximal to the container 1 than the biased resting position. The suction space 5 has a smaller volume in the pressed position than in the biased resting position.

A compression spring 8 having a first end 81 and a second end 82 is disposed in the cap assembly 2. The first end 81 of the compression spring 8 is configured to abut against the actuator assembly 4 to bias the actuator assembly 4 towards the biased resting position. In this embodiment, the actuator 41 is in form of a tubular button having a hollow interior 411. The first end 81 of the compression spring 8 is abutted against a top end of the hollow interior 411. The second end 82 of the compression spring 8 is configured to abut against the tube assembly 3 to bias the tube assembly 3 towards the ready-to-dispense position. In this embodiment, the second end 82 of the compression spring 8 is abutted against the third limiting member 71 in form of the flange of the tube assembly 3.

In this embodiment, a wiper 9 is provided in the opening portion 11 of the container 1. The wiper 9 has an inner wall 91 which is tightly sleeved on an outer surface 321 of the tube 32.

The operation of the dispensing container 100 of the present embodiment is as follows:

Initially, the cap assembly 2 is completely engaged with the opening portion 11 of the container 1. More particularly, the threaded inner surface 221 of the inner cap 22 of the cap assembly 2 is threadedly engaged with and completely covers the opening portion 11 in form of threaded neck opening of the container 1. The tube assembly 3 is at the default position where the tube seat 31 is distal from the bottom end of the cap assembly 2. At the default position, the first limiting member 61 formed by the bottom end of the tube seat 31 is abutted against the second limiting means 62 formed by the top end of the opening portion 11, i.e. the upper rim of the opening portion 11 (with the top rim of the wiper 9 in-between in this embodiment as the wiper 9 is assembled to the opening portion 11 of the container 1), so that the bottom end of the tube seat 31 is limited from moving further towards the bottom end of the cap assembly 2; the piston 42 is positioned at the non-suction position in relation to the tube seat 31, and the suction space 5 has the first volume. Furthermore, the bottom end of the tube 32 is positioned adjacent to a bottom end of the container 1.

When the user needs to retrieve the liquid content from the container 1, the user disengages the cap assembly 2 from the container 1 by unscrewing the cap assembly 2 from the opening portion 11 of the container 1. As the cap assembly 2 is disengaged from the opening portion 11 of the container 1 and moves upwards, the first limiting member 61 formed by the bottom end of the tube seat 31 moves away from the second limiting member 62 formed by the top end of the opening portion 11, i.e. the upper rim of the opening portion 11, and the bottom end of the tube seat 31 is biased by the compression spring 8 to move downwards in relation to the cap assembly 2 until it reaches the second limiting member 62 formed by the top end of the opening portion 11, i.e. the upper rim of the opening portion 11 when the cap assembly 2 is still partially engaged with the opening portion 11 of the container 1; subsequently, when the third limiting member 71 in form of the flange radially protruding from an outer circumferential surface of the tube seat 31 reaches a position to abut against the fourth limiting member 72 in form of the upper rim of the inner cap 22, the bottom end of the tube seat 31 is limited from moving further towards the bottom end of the cap assembly 2; at this time, the tube assembly 3 reaches the ready-to-dispense position, and the cap assembly 2 is then completely disengaged from the container 1. Since the piston 42 is fixed in position in relation to the cap assembly 2 when the actuator 41 is not actuated, the downward movement of the tube seat 31 in relation to the cap assembly 2 causes the position of the piston 42 relative to the tube seat 31 to change from the non-suction position to the suction position which is more distal from the bottom end of the tube seat 31, thereby increasing the volume of the suction space 5 from the first volume to the second volume, and thus sucking the liquid content in the container 1 into the suction space 5.

When the user needs to apply the liquid content onto his skin, the user actuates the actuator assembly 4 by pressing the actuator 41 downwards, thereby also driving the piston 42 to move downwards along the tube seat 31 from the biased resting position to reach the pressed position; as a result, the volume of the suction space 5 decreases, and the liquid content previously sucked into the suction space 5 is discharged via the tube 32 to the user’s skin. When the user stops pressing the actuator 41, the actuator 41 is biased by the compression spring 8 to restore to the biased resting position.

After the user finishes applying the liquid content onto his skin, the user screws the cap assembly 2 to the opening portion 11 of the container 1 again. As the cap assembly 2 moves downwards towards the opening portion 11 of the container 1, the tube assembly 3 is moved from the ready-to-dispense position to the default position where the bottom end of the tube seat 31 is limited from moving further towards the bottom end of the cap assembly 2 by the first limiting means 6, and the cap assembly 2 is completely engaged with the opening portion 11 of the container 1. Since the piston 42 is fixed in position in relation to the cap assembly 2 when the actuator 41 is not actuated, the upward movement of the tube seat 31 in relation to the cap assembly 2 causes the position of the piston 42 relative to the tube seat 31 to change from the suction position to the non-suction position which is more proximal to the bottom end of the tube seat 31, thereby decreasing the volume of the suction space 5 to the first volume.

By means of the present invention, the operation of the dispensing container 100 is convenient. When the user disengages the cap assembly 2 from the container 1, the liquid content in the container 1 is automatically sucked into the suction space 5 without the need to tilt and insert the dropper tube into the container and squeeze the bulb of the dropper tube as in conventional dropper bottles, and the user can directly actuate the actuator assembly 4 to dispense the liquid content to his skin.

Furthermore, as the extent of the movement of the tube assembly 3 from the default position to the ready-to-dispense position is fixed by the first limiting means 6 and the second limiting means 7, it is possible to ensure a fixed volume of liquid content to be sucked from the container 1 into the suction space 5 each time when the user disengages the cap assembly 2 from the container 1, thereby achieving dosage accuracy.

Besides, as the bottom end of the tube 32 is positioned adjacent to the bottom end of the container 1 when the tube assembly 3 is at the default position, the tube 32 could always suck the liquid content from the bottom of the container 1 to the suction space 5, ensuring no residue or wastage of the liquid content in the container 1.

The embodiments described above are exemplary embodiments of the present invention. It is understood that the present invention should not be limited to the embodiments as described. Any changes, modifications, replacements, combinations and simplification without deviating from the essence and principle of the present invention should be considered alternative configurations that are equally effective and should also fall within the scope of protection of the present invention.

What is claimed is:

1. A dispensing container comprising
a container for receiving liquid content therein;
a cap assembly removably engaged with an opening portion of the container;
a tube assembly comprising a tube seat movably received within the cap assembly and a tube extended from a bottom end of the tube seat into the container;
an actuator assembly having an actuator and a piston fixedly coupled to the actuator and movably received within the tube seat;
a suction space formed within the tube assembly between the piston and the bottom end of the tube seat;
the tube assembly being axially movable in relation to the cap assembly between a default position where the tube seat is distal from a bottom end of the cap assembly and a ready-to-dispense position where the tube seat is proximal to the bottom end of the cap assembly; at the default position, the bottom end of the tube seat is limited from moving further towards the bottom end of the cap assembly by a first limiting means, the piston is positioned at a non-suction position in relation to the tube seat and the suction space has a first volume; at the ready-to-dispense position, the bottom end of the tube seat is limited from moving further towards the bottom end of the cap assembly by a second limiting means, the piston is positioned at a suction position in relation to the tube seat and the suction space has a second volume; the suction position is more distal from the bottom end of the tube seat than the non-suction position, and the second volume is larger than the first volume;
the actuator assembly being axially movable in relation to the cap assembly between a biased resting position and a pressed positon which is more proximal to the container than the biased resting position, and the suction space has a smaller volume in the pressed position than in the biased resting position.

2. The dispensing container as in claim 1, wherein a compression spring having a first end and a second end is disposed in the cap assembly; the first end of the compression spring is configured to abut against the actuator assembly to bias the actuator assembly towards the biased resting position; the second end of the compression spring is configured to abut against the tube assembly to bias the tube assembly towards the ready-to-dispense position.

3. The dispensing container as in claim 2, wherein the second limiting means comprises a third limiting member radially protruding from an outer circumferential surface of the tube seat and a fourth limiting member disposed in the cap assembly; the third limiting member is abutted against the fourth limiting member to prevent the tube seat from moving further towards the bottom end of the cap assembly.

4. The dispensing container as in claim 3, wherein the third limiting member is in form of a flange radially protruding from the outer circumferential surface of the tube seat.

5. The dispensing container as in claim 3, wherein the second end of the compression spring is abutted against the third limiting member radially protruding from an outer circumferential surface of the tube seat.

6. The dispensing container as in claim 2, wherein the first limiting means comprises a first limiting member formed by the bottom end of the tube seat and a second limiting member formed by a top end of the opening portion; the bottom end of the tube seat is abutted against the top end of the opening portion to prevent the tube seat from moving further towards the bottom end of the cap assembly.

7. The dispensing container as in claim 1, wherein the tube is configured to have a length such that when the tube assembly is at the default position, a bottom end of the tube is positioned adjacent to a bottom end of the container.

8. The dispensing container as in claim 1, wherein the cap assembly comprises
an outer cap having a hollow interior; and
an inner cap fixedly coupled to a bottom end of the hollow interior of the outer cap and provided with a threaded inner surface to threadedly engage with the opening portion of the container.

9. The dispensing container as in claim 8, wherein the second limiting means comprises a third limiting member radially protruding from an outer circumferential surface of the tube seat and a fourth limiting member disposed in the cap assembly; the third limiting member is abutted against the fourth limiting member to prevent the tube seat from moving further towards the bottom end of the cap assembly; the fourth limiting member is form of an upper rim of the inner cap.

10. The dispensing container as in claim 2, wherein the actuator is in form of a tubular button having a hollow interior; the first end of the compression spring is abutted against a top end of the hollow interior.

11. The dispensing container as in claim 1, wherein the opening portion is in form of a threaded neck opening at a top end of the container.

12. The dispensing container as in claim 1, wherein a wiper is provided in the opening portion of the container; the wiper has an inner wall which is tightly sleeved on an outer surface of the tube.
